(19) United States
(12) Patent Application Publication
(10) Pub. No.: US 2010/0257873 A1
(43) Pub. Date: Oct. 14, 2010

(54) METHOD FOR CONTROLLING THE WITHDRAWAL OF GAS

(76) Inventors: Ulrich Mueller, Neustadt (DE); Frank Poplow, Ludwigshafen (DE); Markus Schubert, Ludwigshafen (DE); Jan-Michael Graehn, Stuttgart (DE); Werner Gruenwald, Gerlingen (DE); Ian Faye, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/746,705

(22) PCT Filed: Nov. 17, 2008
(86) PCT No.: PCT/EP08/65686

§ 371 Date: Jun. 7, 2010

(30) Foreign Application Priority Data
Dec. 6, 2007 (DE) 102007058671.1

(51) Int. Cl. F17C 11/00; B65B 3/00

(52) U.S. Cl. 62/46.1; 206/7

(57) ABSTRACT

The invention relates to a method for controlling the withdrawal of gas from a sorption reservoir. The temperature in the sorption reservoir having a decreasing amount of gas therein is increased until a maximum acceptable temperature is reached such that a predetermined minimum pressure in the sorption reservoir does not fall below that threshold. The invention also relates to a device for storing at least one gas, having a sorption reservoir that has at least one attachment via which the sorption reservoir can be filled with gas or via which gas can be withdrawn from the sorption reservoir. The invention also relates to a device having at least one heating element which can warm the sorption reservoir, also a control system that can increase the temperature in the sorption reservoir when withdrawing the gas in such a manner that a predetermined minimum temperature in the sorption reservoir is not fallen below in order to attain a maximum acceptable pressure.

### PRIOR ART

The invention relates to a method for regulating the withdrawal of gas from a sorption reservoir as well as a device for storing at least one gas as recited in the preamble to claim 9.

Currently, natural gas, e.g. for use in gas-powered motor vehicles, is usually stored at a pressure of 200 bar and at ambient temperature. When the vehicle is to be operated with hydrogen, for example in a vehicle with a fuel-cell-based drive system, then hydrogen is used as the fuel. This is usually stored at pressures in the range from 300 bar to 700 bar and at ambient temperature.

A liquid storage of hydrogen would permit a comparatively high storage density, but requires a very low temperature of 20 K. This requires a high level of technical complexity and expenditure of energy in order to cool and liquefy the hydrogen. The energy expenditure for cooling and liquefying constitutes more than 30% of the energy content in the tank.

Sorption reservoirs represent an alternative to liquid storage of hydrogen. Particularly at low temperatures, the sorption of gas is very high in highly porous materials such as porous metal-organic frameworks (MOF). Temperatures at which the sorption storage of hydrogen occurs in large quantities lie, for example, in the vicinity of the boiling temperature of nitrogen, which at a pressure of one bar, occurs at 77 K. At such temperatures, storage of this kind is also referred to as cryostorage.

A sorption reservoir for hydrogen is known, for example, from U.S. Pat. No. 6,748,748. In it, a container contains a porous material in which hydrogen is sorbed. The storage takes place at a temperature in a range between 30 K and 270 K. In order to maintain the temperature in the container, it is thermally insulated. To this end, two walls are used, for example, between which a vacuum is provided.

Another sorption reservoir for storing hydrogen is known, for example, from U.S. Pat. No. 6,672,077. Here, too, a container contains a material that sorbs hydrogen. In order to cool the reservoir, it is provided with a cooling unit that operates with liquid nitrogen. The sorption reservoir also contains a heating element that can increase the temperature to a value above the desorption temperature for hydrogen in order to withdraw the hydrogen from the reservoir.

DE-A 10 2007 005 366 likewise discloses a sorption reservoir for gas. This reservoir is provided with a device with which the reservoir can be cooled for adsorption. In order to permit a desorption of the gas, heat is supplied. This occurs either through the introduction of a warm gas or through heating by means of a heating coil.

A disadvantage of the method known from the prior art is the fact that the hydrogen can only be withdrawn from the sorption reservoir until a minimum pressure is reached. When the minimum pressure is reached, however, a very large quantity of gas still remains in the tank and cannot be accessed.

### DISCLOSURE OF THE INVENTION

With the method according to invention for regulating the withdrawal of gas from a sorption reservoir, as the content of gas in the sorption reservoir decreases, the temperature in the sorption reservoir is increased so that the pressure in the sorption reservoir does not fall below a predetermined minimum pressure until a maximum permissible temperature is reached.

The increasing of the temperature causes the storage capacity of the sorption reservoir to decrease. Consequently, more and more gas is released. The maximum permissible temperature up to which the sorption reservoir is heated is selected so that only an extremely small quantity of gas remains in the sorption reservoir.

The predetermined minimum pressure depends on the consumer units to be supplied with the gas from the sorption reservoir. For example, when using the sorption reservoir in vehicles, a minimum pressure is required in order to be able to continue to provide the desired mass of gas using predetermined valve cross sections. This is necessary in order to achieve the desired rated output. Below the minimum pressure, it is necessary to accept output losses or it is possible that the gas-metering valves no longer open. For example, the gas-consumer units in the vehicle include are the engine in gas-powered internal combustion engines or the fuel cell.

One advantage of the method according to the invention is that it significantly increases the usable tank capacity, which makes it possible to implement either a reduced space for the tank equipped with the sorption reservoir or a greater cruising range when used in a vehicle. In addition, the maximum output is available, i.e. a constant gas pressure, until the tank is essentially empty.

In a first embodiment, the raising of the temperature in the sorption reservoir until the maximum permissible temperature is reached occurs by means of a step-by-step increase of the temperature that includes the following steps:
(a) withdrawal of gas at a constant temperature until a predetermined threshold value for the pressure is reached,
(b) increase of the temperature in the sorption reservoir until the pressure in the sorption reservoir reaches a predetermined upper pressure limit,
(c) possible repetition of steps (a) and (b) until a maximum permissible temperature is reached.

Because of the decreasing sorption capacity of the sorption reservoir as the temperature rises, the temperature increase causes the pressure in the tank to rise. It is therefore necessary when increasing the temperature to make sure that a maximum permissible tank pressure is not exceeded. An excessive pressure could otherwise result in a damage to the tank that may possibly even cause the tank to burst. Particularly at high temperatures, it is only necessary to carry out slight temperature increases since even small temperature increases result in a significant increase in the pressure.

In order to prevent the pressure from exceeding the maximum permissible pressure of the tank during the heating, it is therefore preferable for the predetermined upper pressure limit—up to the achievement of which the temperature is increased in step (b)—to correspond to the maximum permissible reservoir pressure.

Since a pressure drop to below the predetermined minimum pressure results, for example, in an output decrease of the gas-powered internal combustion engine or fuel cell, it is preferable for the predetermined threshold value for step (a) to assume a value that lies between the predetermined minimum pressure and a pressure that is 20% greater than the predetermined minimum pressure. This assures that the pressure during gas withdrawal does not fall below the predetermined minimum pressure. The upper limit of the range, which is 20% greater than the predetermined minimum pressure, is selected so that a maximum possible gas quantity can be withdrawn from the sorption reservoir at the achieved temperature. The upper limit of the range depends, among other things, on the gas stored, the sorption material used, and the ratio of the size of the sorption reservoir to the outflow speed of the gas.

The step-by-step increase of the temperature permits a comparatively simple 2-point regulation.

The heating of the sorption reservoir is carried out, for example, by means of a heating unit that is situated in the tank. The heating can, for example, take place through the exchange of heat with a heating medium. It is also possible, however, for the heating to be carried out by means of electrical heating elements, for example. Alternatively, however, with low-temperature storage, it is also possible for the heating to take place by means of a selective interruption of the thermal insulation of the tank. The selective interruption of the thermal insulation can be achieved, for example, by means of thermal bridges that are preferably switchable.

When heating the tank by means of a heating medium, usually a fluid heating medium is used. This medium is cooled by the heating of the tank. The heating medium cooled in this fashion can, for example, be used for controlling the temperature of the interior of a motor vehicle in which the method according to the invention for regulating the withdrawal of a gas from a sorption reservoir is used.

In an alternative embodiment, once a predetermined pressure is reached, as gas is being withdrawn, the temperature in the sorption tank is increased in such a way that the pressure remains essentially constant until a predetermined maximum permissible temperature is reached. In order to achieve as complete as possible an emptying of the tank, it is preferable if the predetermined pressure—up to the achievement of which the temperature in the sorption tank is increased—is essentially equal to the predetermined minimum pressure. In this case, “essentially equal to the predetermined minimum pressure” also means that the predetermined pressure lies in the range between the minimum pressure and a pressure that is at most 10% greater than the predetermined minimum pressure.

By contrast with the step-by-step increase of the temperature, when the temperature is regulated so that the pressure remains essentially constant, a greater regulating complexity is required.

According to the invention, gas continues to be withdrawn from the sorption reservoir until the maximum permissible temperature and the predetermined minimum pressure have been achieved. The maximum permissible temperature in this case is determined in such a way that the sorption reservoir is emptied as completely as possible so as to be able to utilize the capacity of the sorption reservoir as fully as possible.

The invention also relates to a device for storing at least one gas, including a sorption reservoir that has at least one connection via which the sorption reservoir can be filled with gas or via which gas can be withdrawn from the sorption reservoir and at least one heating element by means of which the sorption reservoir can be heated. The device also includes a control system by means of which during the withdrawal of gas, the temperature in the sorption reservoir can be increased in such a way that until a maximum permissible temperature is reached, the pressure in the sorption reservoir does not fall below a predetermined minimum pressure.

By means of the control system, it is possible to carry out the method according to the invention for the withdrawal of gas from the device. For example, the device according to the invention is a fuel tank of the type used in motor vehicles.

In one embodiment, the sorption reservoir is provided with a cooling unit in order to permit a low-temperature storage. A low-temperature storage is particularly preferable when storing hydrogen.

In one embodiment, the control system has at least one pressure sensor and at least one temperature sensor by means of which the pressure and temperature in the sorption reservoir can be detected. The detection of pressure and temperature is necessary in order to increase the temperature so that on the one hand, the pressure does not fall below the predetermined minimum pressure during withdrawal of the gas and on the other hand, the pressure does not exceed the maximum pressure in the tank as the temperature is being increased.

The sorption reservoir preferably contains zeolites, activated charcoal, or metal-organic frameworks (MOF). These materials are particularly suitable for the storage of hydrogen. However, gaseous hydrocarbons can also be stored in these materials.

In order to fill and empty the sorption reservoir, it is possible on the one hand for a connection equipped with a valve to be provided via which the sorption reservoir is initially filled with gas. Once the sorption reservoir has been completely filled, gas can also be withdrawn again via the same connection. In an alternative embodiment, however, two separate connections are provided. One connection for the filling of the sorption reservoir and one connection for the withdrawal of gas from the sorption reservoir. The two connections are particularly advantageous when the sorption reservoir is used in a vehicle. In this way, the sorption reservoir can be filled with gas via a supply fitting. For this purpose, the end of the supply fitting is preferably situated on the outside of the vehicle body in order to permit the tank to be filled easily. The gas can be withdrawn again via a second connection. To this end, the second connection is connected, for example, to the engine in a gas-powered internal combustion engine or is connected to the fuel cell if the vehicle is operated by means of a fuel cell.

The method according to the invention and the device according to the invention are suitable for sorption reservoirs that store hydrogen or gaseous hydrocarbons such as natural gas, methane, ethane, propane, or butane.

### BRIEF DESCRIPTION OF THE DRAWINGS

Exemplary embodiments of the invention are shown in the drawings and will be explained in detail in the subsequent description.

FIG. 1A shows adsorption isotherms for hydrogen in Zn MOFs,

FIG. 1B shows hydrogen adsorption isotherms in Cu MOFs,

FIG. 2 shows a first embodiment of the method for gas withdrawal according to the invention,

FIG. 3 shows a second embodiment of the method for gas withdrawal according to the invention,

FIG. 4 shows a device according to the invention for storing at least one gas.

### EMBODIMENTS OF THE INVENTION

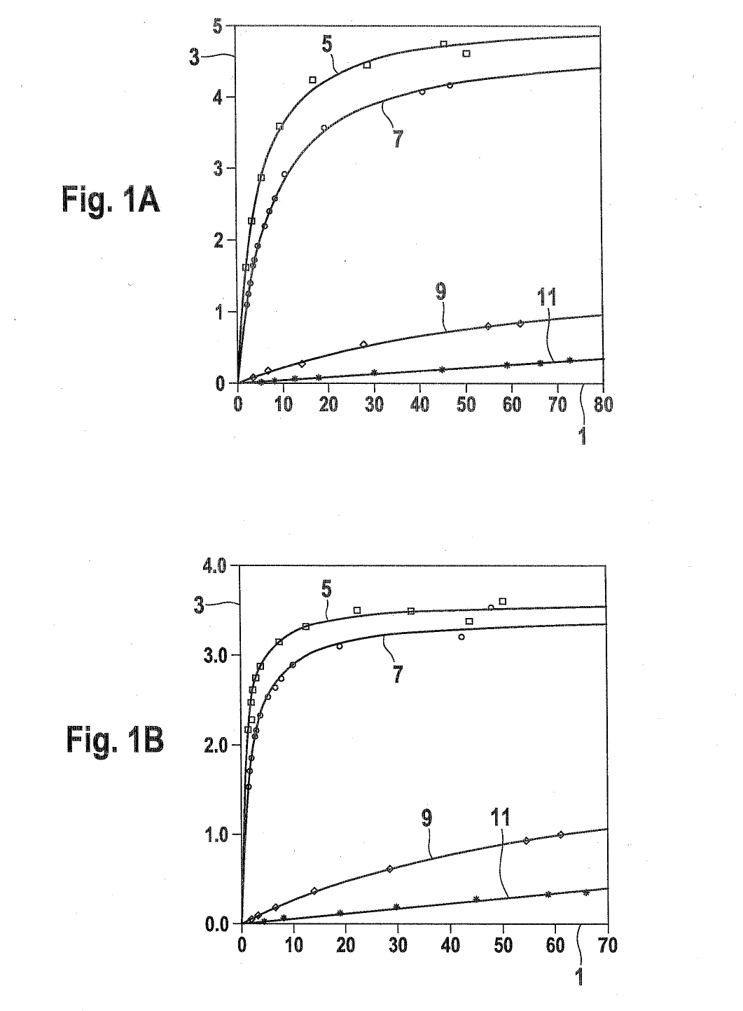

FIG. 1A shows adsorption isotherms for hydrogen in a Zn MOF. The pressure of the hydrogen expressed in bar is plotted on the x axis 1 and the hydrogen content in the sorption reservoir expressed in wt. % is plotted on the y axis 3. The graph includes a first adsorption isotherm 5 at a temperature of 77 K, a second adsorption isotherm 7 at a temperature of 87 K, a third adsorption isotherm 9 at a temperature of 200 K, and a fourth adsorption isotherm 11 at a temperature of 298 K.

The graph in FIG. 1A shows that with a constant pressure, the hydrogen charge decreases as the temperature increases. It is also clear that at low temperatures, already in the low-pressure range, the hydrogen charge is very much greater than the maximum possible charge at higher temperatures. Because of the lower charging potential at higher temperatures, hydrogen is released from the sorption reservoir when the temperature is increased. This also simultaneously increases the pressure in the reservoir. It is thus possible at a constant pressure to withdraw more gas from the sorption reservoir due to the increasing temperature.

FIG. 1B shows the adsorption isotherms for a Cu MOF. For example, Cu₃(BTC)₂ is used as the Cu MOF.

In FIG. 1B as well, the pressure of the hydrogen expressed in bar is plotted on the x axis 1 and the amount of hydrogen in the sorption reservoir expressed in wt. % is plotted on the y axis 3. The first adsorption isotherm 5 shows the hydrogen content as a function of pressure at a temperature of 77 K, the second adsorption isotherm 7 shows it at 87 K, the third adsorption isotherm 9 shows it at 200 K, and the fourth adsorption isotherm 11 shows it at 298 K.

FIGS. 1A and 1B show that a similar behavior occurs in both copper-based metal-organic frameworks and zinc-based metal-organic frameworks. This behavior is typical for all sorption materials. Consequently, the method according to the invention can be used for all sorption materials known to the person skilled in the art in order to increase the storage capacity and to withdraw essentially all of the gas from the tank by increasing the temperature.

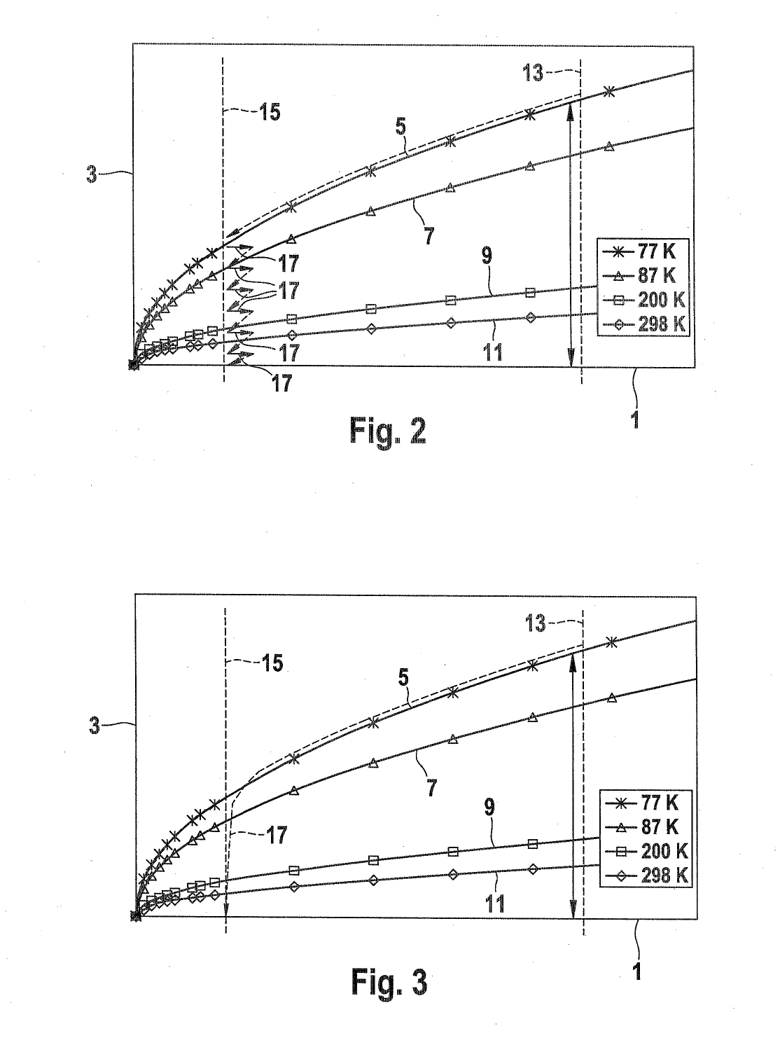

A first embodiment of the method is schematically depicted in FIG. 2. In FIG. 2 as well, the pressure of the hydrogen is plotted on the x axis 1 and the mass of gas in the reservoir is plotted on the y axis 3. In FIG. 2 as well, four sample adsorption isotherms 5, 7, 9, 11 at different temperatures are once again shown as examples.

The maximum charge of the sorption reservoir is a function of a maximum permissible pressure 13 in the tank and the minimum temperature that is achieved. In order to empty the reservoir, gas is initially withdrawn from the reservoir until a minimum pressure 15 is reached. The minimum pressure 15 is generally a function of the pressure requirements of the gas-consumer unit, for example an internal combustion engine or fuel cell. It is thus necessary to accept output losses when the pressure falls below the minimum pressure 15. It is also possible, for example, that metering valves no longer open if the pressure is below the minimum pressure 15.

FIG. 2 shows a step-by-step withdrawal of gas. To achieve this, gas is initially withdrawn from the sorption reservoir at a constant temperature. If the sorption reservoir is charged to the maximum, the charge decreases with decreasing pressure in accordance with the first adsorption of isotherm 5. As soon as the pressure approaches the minimum pressure 15, the temperature is increased. The temperature increase causes the pressure to rise when the charge remains the same. This is depicted with the arrow 17. The heating is terminated when the temperature reaches a predetermined threshold value that lies above the pressure at which the withdrawal is terminated. This occurs, for example, when an electrically actuated heating unit is switched off or when the heating by means of a heat exchanger is terminated.

The withdrawal of gas from the sorption reservoir is continued until the pressure has reached a certain proximity to the minimum pressure. Finally, the heating is resumed until the pressure has once again reached the upper threshold value. This is repeated as often as necessary until either all of the gas has been withdrawn from the reservoir or a predetermined temperature is reached. The predetermined maximum temperature can, for example, also be determined based on the residual quantity that should remain in the sorption reservoir after the gas withdrawal. Naturally, the gas withdrawal can also be carried out during the heating of the sorption reservoir.

In order to prevent the pressure from falling below the predetermined minimum pressure 15 during the withdrawal, the heating is preferably begun as soon as the pressure lies in a range between the minimum pressure 15 and a pressure that is at most 20% greater than the predetermined minimum pressure. The pressure at which the heating is begun also depends on the available heating output. This determines the speed at which the sorption reservoir can be heated.

In order to also prevent the temperature increase from causing the pressure to exceed the maximum permissible pressure 13, the heating is preferably only carried out until a pressure is reached that is it most 50% greater than the predetermined minimum pressure. It is necessary in any case to prevent the pressure from exceeding the maximum permissible temperature 13 in order to avoid a damage to the tank, which may even be serious enough to cause the tank to burst. The maximum permissible pressure 13 is thus in particular a function of the strength of the tank. It is also possible for the maximum pressure to be a function of the properties of the withdrawal valve; it is thus possible, for example, to use a withdrawal valve that can no longer open at pressures above the maximum pressure 13.

FIG. 3 shows a second embodiment of the method for gas withdrawal according to the invention. The embodiment shown in FIG. 3 differs from the embodiment shown in FIG. 2 in that the temperature is not increased in step-by-step fashion but instead, a continuous temperature increase is carried out as the gas is being withdrawn. The temperature in this case is increased so that the pressure remains essentially constant during the withdrawal of gas. This is demonstrated by the withdrawal curve 17. Preferably, the pressure that is kept essentially constant by means of the temperature increase corresponds to the minimum pressure 15. This ensures that by means of the temperature increase, the maximum possible quantity of gas is withdrawn from the sorption reservoir without unnecessary heating.

Whereas in the embodiment shown in FIG. 2, a simple 2-point regulation is sufficient to carry out the step-by-step temperature increase, in the embodiment shown in FIG. 3, a continuous regulation must take place in order to prevent the pressure from falling below the minimum pressure during withdrawal.

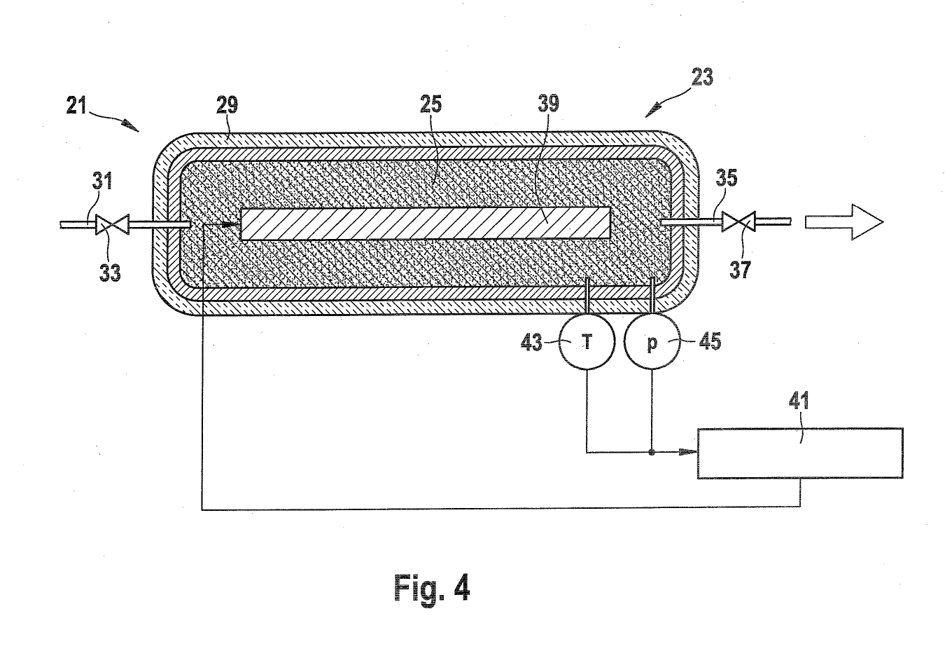

FIG. 4 schematically depicts a device according to the invention for storing at least one gas.

A device 21 for storing a gas includes a tank 23 that contains a sorption reservoir 25. The sorption reservoir 25 is preferably a porous metal-organic framework (MOF). Other suitable sorption reservoirs include, for example, activated charcoal or zeolites.

Metal-organic frameworks are described, for example, in U.S. Pat. No. 5,648,508; EP-A 0 790 253; M. O'Keeffe et al., J. Sol. State Chem., 152 (2000), pages 3 through 20; H. Li et al., Nature 402 (1999), page 276; M. Eddaoudi et al., Topics in Catalysis 9 (1999), pages 105 through 111; B. Chen et al., Science 291 (2001), pages 1021 through 1023; and DE-A 101 11 230.

The MOFs according to the present invention contain pores, in particular micropores and/or mesopores. Micropores are defined as pores with a diameter of 2 nm or less and mesopores are defined as pores with a diameter in the range from 2 to 50 nm, each according to the definition given in Pure Applied Chem. 45, page 71, in particular on page 79 (1976). The presence of micropores and/or mesopores can be checked with the aid of sorption measurements; these measurements determine the nitrogen sorption capacity of metal-organic framework materials at 77 Kelvin according to DIN 66131 and/or DIN 66134.

The specific surface area—calculated according to the Langmuir model (DIN 66131, 66134) for an MOF in powdered form—is preferably greater than 5 m²/g, more preferably greater than 10 m²/g, more preferably greater than 50 m²/g, even more preferably greater than 500 m²/g, even more preferably greater than 1000 m²/g, and particularly preferably greater than 1500 m²/g.

Shaped articles made of MOF can have a lower specific surface area; preferably, however, greater than 10 m²/g, more preferably greater than 50 m²/g, even more preferably greater than 500 m²/g, and in particular greater than 1000 m²/g.

The metal components in the framework material according to the present invention are preferably selected from the groups Ia, IIa, IIIa, IVa through VIIIa, and Ib through VIb. Particularly preferable selections include Mg, Ca, Sr, Ba, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Hg, Al, Ga, In, T1, Si, Ge, Sn, Pb, As, Sb, and Bi. More preferable selections include Zn, Cu, Mg, Al, Ga, In, Sc, Y, Lu, Ti, Zr, V, Fe, Ni, and Co. Especially preferable selections include Cu, Zn, Al, Fe, and Co. With regard to the ions of these elements, particular mention should be made of Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺As⁺, Sb⁵⁺, Sb³⁺, Sb⁺, Bi⁵⁺, Bi³⁺, and Bi⁺.

The expression “at least bidentate organic compound” refers to an organic compound that contains at least one functional group that is in a position to form at least two bonds, preferably two coordinate links, to a given metal ion and/or to form a respective coordinate link to each of two or more, preferably two, metal atoms.

Functional groups by means of which the above-mentioned coordinate links can be formed include in particular the following functional groups, for example: —CO₂H, —CS₂H, —NO₂, —B(OH)₂, —SO₃H, —Si(OH)₃, —Ge(OH)₃, —Sn(OH)₃, —Si(SH)₄, —Ge(SH)₄, —Sn(SH)₃, —PO₃H, —AsO₃H, —AsO₄H, —P(SH)₃, —As(SH)₃, —CH(RSH)₂, —C(RSH)₃, —CH(RNH₂)₂, —C(RNH₂)₃, —CH(ROH)₂, —C(ROH)₃, —CH(RCN)₂, —C(RCN)₃, where R preferably represents, for example, an alkylene group with 1, 2, 3, 4, or 5 carbon atoms, e.g. a methylene, ethylene, n-propylene, i-propylene, n-butylene, i-butylene, tert-butylene, or n-pentylene group or an aryl group containing 1 or 2 aromatic nuclei, such as 2 C₆ rings that can optionally be condensed and can each be suitably substituted, independently of each other, with at least one respective substituent and/or can each contain, independently of each other, at least one heteroatom such as N, O, and/or S. According to likewise preferred embodiments, functional groups that do not contain the above-mentioned group R should be mentioned. Among others, these include —CH(SH)₂, —C(SH)₃, —CH(NH₂)₂, —C(NH₂)₃, —CH(OH)₂, —C(OH)₃, —CH(CN)₂, or —C(CN)₃.

The at least two functional groups can be bonded to essentially any suitable organic compound as long as the organic compound having the functional groups is capable of forming the coordinate link and is suitable for the manufacture of the framework material.

Preferably, the organic compounds that contain the at least two functional groups are derived from a saturated or unsaturated aliphatic compound, an aromatic compound, or a compound that is both aliphatic and aromatic.

The aliphatic compound or the aliphatic part of the compound that is both aliphatic and aromatic can be linear and/or branched, and/or cyclic; it is also possible for there to be several cycles per compound. The aliphatic compound or the aliphatic part of the compound that is both aliphatic and aromatic preferably contains 1 to 15, more preferably 1 to 14, more preferably 1 to 13, more preferably 1 to 12, more preferably 1 to 11, and particularly preferably 1 to 10 C atoms, such as 1, 2, 3, 4, 5, 6, 7, 8, 9, or 10 C atoms. Particularly preferred examples of this include, among others, methane, adamantane, acetylene, ethylene, or butadiene.

The aromatic compound or the aromatic part of the compound that is both aromatic and aliphatic can have one or more nuclei, for example two, three, four, or five nuclei; the nuclei can be separate from one another and/or at least two nuclei can be in condensed form. In a particularly preferred embodiment, the aromatic compound or the aromatic part of the compound that is both aliphatic and aromatic has one, two, or three nuclei; it is particularly preferable for it to have one or two nuclei. Furthermore, each nucleus of the above-mentioned compound, independently of the others, can contain at least one heteroatom such as N, O, S, B, P, Si, Al, preferably N, O, and/or S. More preferably, the aromatic compound or the aromatic part of the compound that is both aromatic and aliphatic contains one or two C6 nuclei; the two nuclei are either separate from each other or are in condensed form. In particular, benzene, naphthalene, and/or biphenyl and/or bipyridyl and/or pyridyl should be mentioned as aromatic compounds.

Particularly preferably, the at least bidentate organic compound is derived from a dicarboxylic, tricarboxylic, or tetracarboxylic acid or their sulfur-based analogues. Sulfur-based analogues are the functional groups —C(═O)SH and their tautomers and C(═S)SH, which can be used in lieu of one or more carboxylic acid groups.

In the context of the present invention, the term “derived” means that the at least bidentate organic compound in the framework material can be in a partially deprotonated or fully deprotonated form. Furthermore, the at least bidentate organic compound can contain other substituents such as —OH, —NH₂, —OCH₃, —CH₃, —NH(CH₃), —N(CH₃)₂, —CN, and halogenides.

In the context of the present invention, for example, mention should be made of dicarboxylic acids such as:

oxalic acid, succinic acid, tartaric acid, 1,4-butane dicarboxylic acid, 4-oxo-pyran-2,6-dicarboxylic acid, 1,6-hexane dicarboxylic acid, decane dicarboxylic acid, 1,8-heptadecane dicarboxylic acid, 1,9-heptadecane dicarboxylic acid, heptadecane dicarboxylic acid, acetylene dicarboxylic acid, 1,2-benzene dicarboxylic acid, 2,3-pyridine dicarboxylic acid, pyridine-2,3-dicarboxylic acid, 1,3-butadiene-1,4-dicarboxylic acid, 1,4-benzene dicarboxylic acid, p-benzene dicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimide dicarboxylic acid, pyridine-2,6-dicarboxylic acid, 2-methylimidazole-4,5-dicarboxylic acid, thiophene-3,4-dicarboxylic acid, 2-isopropyl imidazole-4,5-dicarboxylic acid, tetrahydropyran-4,4-dicarboxylic acid, perylene-3,9-dicarboxylic acid, perylene dicarboxylic acid, Pluriol E 200-dicarboxylic acid, 3,6-dioxaoctane dicarboxylic acid, 3,5-cyclohexadiene-1,2-dicarboxylic acid, octadicarboxylic acid, pentane-3,3-carboxylic acid, 4,4′-diamino-1,1′-diphenyl-3,3″-dicarboxylic acid, 4,4′-diaminodiphenyl-3,3′-dicarboxylic acid, benzidine-3,3′-dicarboxylic acid, 1,4-bis-(phenylamino)-benzene-2,5-dicarboxylic acid, 1,1′-dinaphthyl-5,5′-dicarboxylic acid, 7-chloro-8-methylquinoline-2,3-dicarboxylic acid, 1-anilinoanthraquinone-2,4″-dicarboxylic acid, polytetrahydrofuran-250-dicarboxylic acid, 1,4-bis-(carboxymethyl)-piperazine-2,3-dicarboxylic acid, 7-chloroquinoline-3,8-dicarboxylic acid, 1-(4-carboxy)-phenyl-3-(4-chloro)-phenylpyrazoline-4,5-dicarboxylic acid, 1,4,5,6,7,7,-hexachloro-5-norbornene-2,3-dicarboxylic acid, phenylindandicarboxylic acid, 1,3-dibenzyl-2-oxo-imidazolidine-4,5-dicarboxylic acid, 1,4-cyclohexane dicarboxylic acid, naphthalene-1,8-dicarboxylic acid, 2-benzoyl benzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecane dicarboxylic acid, O-hydroxybenzophenone dicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazine dicarboxylic acid, 5,6-dimethyl-2,3-pyrazine dicarboxylic acid, 4,4′-diaminodiphenyl ether diimide dicarboxylic acid, 4,4′-diaminodiphenyl methane diimide dicarboxylic acid, 4,4′-diaminodiphenyl sulfondiimide dicarboxylic acid, 2,6-naphthalene dicarboxylic acid, 1,3-adamantane dicarboxylic acid, 1,8-naphthalene dicarboxylic acid, 2,3-naphthalene dicarboxylic acid, 8-methoxy-2,3-naphthalene dicarboxylic acid, 8-nitro-2,3-naphthalene dicarboxylic acid, 8-sulfo-2,3-naphthalene dicarboxylic acid, anthracene-2,3-dicarboxylic acid, 2′,3′-diphenyl-p-terphenyl-4,4″-dicarboxylic acid, diphenylether-4,4′-dicarboxylic acid, imidazole-4,5-dicarboxylic acid, 4(1H)-oxothiochromene-2,8-dicarboxylic acid, 5-tert-butyl-1,3-benzene dicarboxylic acid, 7,8-quinoline dicarboxylic acid, 4,5-imidazole dicarboxylic acid, 4-cyclohexene-1,2-dicarboxylic acid, hexatriacontane dicarboxylic acid, tetradecane dicarboxylic acid, 1,7-heptadicarboxylic acid, 5-hydroxy-1,3-benzene dicarboxylic acid, pyrazine-2,3-dicarboxylic acid, furan-2,5-dicarboxylic acid, 1-nonene-6,9-dicarboxylic acid, icosine dicarboxylic acid, 4,4′-dihydroxydiphenylmethane-3,3-dicarboxylic acid, 1-amino-4-methyl-9,10-dioxo-9,10-dihydroanthracene-2,3-dicarboxylic acid, 2,5-pyridine dicarboxylic acid, cyclohexene-2,3-dicarboxylic acid, 2,9-dichlorofluoro-ruby-4,11-dicarboxylic acid, 7-chloro-3-methylquinoline-6,8-dicarboxylic acid, 2,4-dichlorobenzophenone-2′,5′-dicarboxylic acid, 1,3-benzene dicarboxylic acid, 2,6-pyridine dicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazole dicarboxylic acid, 2-nitrobenzene-1,4-dicarboxylic acid, heptane-1,7-dicarboxylic acid, cyclobutane-1,1-dicarboxylic acid, 1,14-tetradecane dicarboxylic acid, 5,6-dehydronorbornane-2,3-dicarboxylic acid, or 5-ethyl-2,3-pyridine dicarboxylic acid,

tricarboxylic acids such as:

2-hydroxy-1,2,3-propane tricarboxylic acid, 7-chloro-2,3,8-quinoline tricarboxylic acid, 1,2,4-benzene tricarboxylic acid, 1,2,4-butane tricarboxylic acid, 2-phosphono-1,2,4 -butane tricarboxylic acid, 1,3,5-benzene tricarboxylic acid, 1-hydroxy-1,2,3-propane tricarboxylic acid, 4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propane tricarboxylic acid, or aurine tricarboxylic acid,

or tetracarboxylic acids such as:

1,1-dioxide perylo[1,12-BCD]thiophene-3,4,9,10-tetracarboxylic acid, perylene tetracarboxylic acids such as perylene-3,4,9,10-tetracarboxylic acid or perylene-1,12-sulfone-3,4,9,10-tetracarboxylic acid, butane tetracarboxylic acids such as 1,2,3,4-butane tetracarboxylic acid or meso-1,2,3,4-butane tetracarboxylic acid, decane-2,4,6,8-tetracarboxylic acid, 1,4,7,10,13,16-hexaoxacyclooctadecane-2,3,11,12-tetracarboxylic acid, 1,2,4,5-benzene tetracarboxylic acid, 1,2,11,12-dodecane tetracarboxylic acid, 1,2,5,6-hexane tetracarboxylic acid, 1,2,7,8-octane tetracarboxylic acid, 1,4,5,8-naphthalene tetracarboxylic acid, 1,2,9,10-decane tetracarboxylic acid, benzophenone tetracarboxylic acid, 3,3′,4,4′-benzophenone tetracarboxylic acid, tetrahydrofuran tetracarboxylic acid, or cyclopentane tetracarboxylic acids such as cyclopentane-1,2,3,4-tetracarboxylic acid.

Quite particularly preferably, at least singly substituted mononucleic, dinucleic, trinucleic, tetranucleic, or higher-nucleic aromatic dicarboxylic acids, tricarboxylic acids, or tetracarboxylic acids are used as needed; each of the nuclei can contain at least one heteroatom; two or more nuclei can contain the same or different heteroatoms. For example, mononucleic dicarboxylic acids, mononucleic tricarboxylic acids, mononucleic tetracarboxylic acids, dinucleic dicarboxylic acids, dinucleic tricarboxylic acids, dinucleic tetracarboxylic acids, trinucleic dicarboxylic acids, trinucleic tricarboxylic acids, trinucleic tetracarboxylic acids, tetranucleic dicarboxylic acids, tetranucleic tricarboxylic acids, and/or tetranucleic tetracarboxylic acids are preferable. Suitable heteroatoms, for example, are N, O, S, B, P, Si, Al and preferable heteroatoms in this case are N, S, and/or O, Suitable substituents in this connection include —OH, a nitro group, an amino group, an alkyl group, or an alkoxy group.

Particularly preferably, at least bidentate organic compounds in the form of acetylene dicarboxylic acid (ADC), benzene dicarboxylic acids, naphthalene dicarboxylic acids, biphenyl dicarboxylic acids such as 4,4′-biphenyl dicarboxylic acid (BPDC), bipyridine dicarboxylic acids such as 2,2′-bipyridine dicarboxylic acids, e.g. 2,2′-bipyridine-5,5′-dicarboxylic acid, benzene tricarboxylic acids such as 1,2,3-benzene tricarboxylic acid or 1,3,5-benzene tricarboxylic acid (BTC), adamantane tetracarboxylic acid (ATC), adamantane dibenzoate (ADB), benzene tribenzoate (BTB), methane tetrabenzoate (MTB), adamantane tetrabenzoate, or dihydroxyterephthalic acids such as 2,5-dihydroxyterephthalic acid (DHBDC) are used.

Quite particularly preferably, isophthalic acid, terephthalic acid, 2,5-dihydroxyterephthalic acid, 1,2,3-benzene tricarboxylic acid, 1,3,5-benzene tricarboxylic acid, or 2,2′-bipyridine-5,5′-dicarboxylic acid are used, among others. In addition to these at least bidentate organic compounds, the MOF can also contain one or more monodentate ligands.

Suitable solvents for manufacturing the MOF include, among others, ethanol, dimethyl formamide, toluene, methanol, chlorobenzene, diethyl formamide, dimethyl sulfoxide, water, hydrogen peroxide, methyl amine, sodium hydroxide solution, N-methylpolidone ether, acetonitrile, benzyl chloride, triethylamine, ethylene glycol, and mixtures thereof. Other metal ions, at least bidentate organic compounds, and solvents for the manufacture of MOFs are described in U.S. Pat. No. 5,648,508 or DE-A 101 11 230, among others.

The pore size of the MOF can be controlled through the selection of the suitable ligand and/or the at least bidentate organic compound. In general, the larger the organic compound, the greater the pore size. With regard to the crystalline material, the pore size is preferably from 0.2 nm to 30 nm; particularly preferably, the pore size lies in the range from 0.3 nm to 3 nm

In a shaped article made of MOF, however, larger pores also occur, whose size distribution can vary. Preferably, however, more than 50% of the total pore volume, in particular more than 75%, is composed of pores with a pore diameter of up to 1000 nm Preferably, however, most of the pore volume is composed of pores from two diameter ranges. It is therefore also preferable if more than 25% of the total pore volume, in particular more than 50% of the total pore volume, is composed of pores that lie in a diameter range from 100 nm to 800 nm and if more than 15% of the total pore volume, in particular more than 25% of the total pore volume, is composed of pores that lie in a diameter range of up to 10 nm. The pore distribution can be determined by means of mercury porosimetry.

The sorption reservoir 25 is preferably cooled to increase its sorption capacity. This is carried out, for example, with the aid of liquid nitrogen. Preferably, the sorption reservoir 25 is enclosed by a thermal insulation 29 in order to prevent a temperature increase induced by the ambient temperature. In addition or alternatively, it is also possible to precool the gas to be stored.

In the embodiment shown in FIG. 4, the sorption reservoir 25 is provided with a first connection 31 with which the sorption reservoir 25 can be filled with gas. In order to prevent an escape of gas from the sorption reservoir 25 via the first connection 31 and also to permit a filling of the reservoir, a refueling valve 33 is accommodated in the first connection 31. The refueling valve 33 is embodied, for example, in the form of a check valve that opens as soon as the pressure in the connection line is greater than the pressure in the sorption reservoir 25. A pressure in the sorption reservoir 25 that is greater than the pressure in the connection line 31 causes the refueling valve 33 to close. This prevents gas from flowing out of the sorption reservoir 25 via the first connection 31. A suitable valve for the refueling valve 33 is a check valve, for example.

Gas is withdrawn from the sorption reservoir 25 via a second connection 35. In order to be able to adjust the quantity and the pressure of the gas that is withdrawn via the second connection 35, a withdrawal valve 37 is preferably situated in the second connection 35.

In order to be able to heat the sorption reservoir and therefore the gas contained therein, a heating element 39 is accommodated in the sorption reservoir. For example, electric heating elements are suitable for use as the heating element 39. Alternatively, however, it is also possible, for example, to use heat exchangers as the heating element 39. Preferably, however, the heating element 39 is an electric heating element.

The device 21 according to the invention also includes a control system 41. The control system 41 controls the heating rate of the heating element 39 so that as gas is being withdrawn, the temperature in the sorption reservoir 25 is increased in such a way that until a maximum permissible temperature is reached, the pressure in the sorption reservoir does not fall below a predetermined minimum pressure. To this end, the temperature is measured with the aid of at least one temperature sensor 43 and the pressure in the sorption reservoir 25 is measured with the aid of a pressure sensor 45 and the values for the temperature and pressure are transmitted to the control system 41.

With a step-by-step increase of the temperature, gas is withdrawn via the second connection 35 until a predetermined threshold value for the pressure is reached. As soon as the pressure measured with the pressure sensor 45 has almost reached the threshold value for the pressure, the control system 41 switches on the heating element 39 in order to increase the temperature in the sorption reservoir 25. For this purpose, the temperature is detected with the aid of the temperature sensor 43. The pressure continues to be detected with the pressure sensor 45. As soon as a predetermined upper pressure limit is reached, which is stored as a value in the control system 41, the heating process is terminated through deactivation of the heating element 39. Gas can continue to be withdrawn via the second connection 35 until the pressure has reached the predetermined threshold value.

If, as in the embodiment shown in FIG. 3, the temperature is to be increased in such a way that the pressure remains essentially constant, the temperature and pressure are detected with the aid of the temperature sensor 43 and the pressure sensor 45 and are processed in the control system 41 so that the heating element 39 is operated in such a way that the pressure measured with the pressure sensor 45 remains essentially constant.

The recording of the temperature with the aid of the temperature sensor 43 is required, particularly in order to determine the maximum permissible temperature in the sorption reservoir 25. The maximum permissible temperature and the minimum pressure establish the state in which the gas withdrawal procedure is terminated. The maximum temperature and the minimum pressure are used to determine the minimum quantity of gas that remains in the sorption reservoir after termination of the withdrawal procedure. The measurement of the temperature also makes it possible to prevent the temperature from exceeding the maximum permissible temperature.

1-13. (canceled)

14. A method for regulating a withdrawal of gas from a sorption reservoir comprising the step of:
as a gas content in the sorption reservoir decreases, increasing temperature in the sorption reservoir until a maximum permissible temperature is reached, while maintaining pressure in the sorption reservoir above a predetermined minimum pressure.

15. The method as recited in claim 14, wherein a step-by-step increase of the temperature is carried out, which includes the following steps:
(a) withdrawing gas at a constant temperature until a predetermined threshold value for the pressure is reached,
(b) increasing the temperature in the sorption reservoir until the pressure in the sorption reservoir reaches a predetermined upper pressure limit,
(c) possibly repeating steps (a) and (b) until a maximum permissible temperature is reached.

16. The method as recited in claim 15, wherein the predetermined upper pressure limit in step (b) corresponds to the maximum permissible reservoir pressure.

17. The method as recited in claim 14, wherein the predetermined threshold value for the pressure in step assumes a value that lies between the predetermined minimum pressure and a pressure that is 20% greater than the predetermined minimum pressure.

18. The method as recited in claim 15, wherein the predetermined threshold value for the pressure in step assumes a value that lies between the predetermined minimum pressure and a pressure that is 20% greater than the predetermined minimum pressure.

19. The method as recited in claim 16, wherein the predetermined threshold value for the pressure in step assumes a value that lies between the predetermined minimum pressure and a pressure that is 20% greater than the predetermined minimum pressure.

20. The method as recited in claim 14, wherein as soon as a predetermined pressure is reached, as gas is being withdrawn, the temperature in the sorption tank is increased in such a way that the pressure remains essentially constant until a predetermined maximum permissible temperature is reached.

21. The method as recited in claim 20, wherein the predetermined pressure—upon achievement of which the temperature in the sorption tank is increased—is essentially equal to the predetermined minimum pressure.

22. The method as recited in claim 14, wherein gas is withdrawn from the sorption tank until the maximum permissible temperature and the predetermined minimum pressure have been reached.

23. The method as recited in claim 14, wherein the gas is hydrogen or a gaseous hydrocarbon.

24. A device for storing at least one gas, including a sorption reservoir that has
at least one connection via which it is possible to fill the sorption reservoir with gas or via which it is possible to withdraw gas from the sorption reservoir,
at least one heating element with which it is possible to heat the sorption reservoir, and
a control system with which it is possible, as gas is being withdrawn, to increase temperature in the sorption reservoir in such a way that until a maximum permissible temperature is reached, pressure in the sorption reservoir does not fall below a predetermined minimum pressure.

25. The device as recited in claim 24, wherein the sorption reservoir is provided with a cooling unit.

26. The device as recited in claim 24, wherein the control system includes at least one pressure sensor and at least one temperature sensor with which the pressure and temperature in the sorption reservoir are detected.

27. The device as recited in claim 25, wherein the control system includes at least one pressure sensor and at least one temperature sensor with which the pressure and temperature in the sorption reservoir are detected.

28. The device as recited in claim 24, wherein the sorption reservoir contains zeolites, activated charcoal, or metal-organic frameworks.

29. The device as recited in claim 25, wherein the sorption reservoir contains zeolites, activated charcoal, or metal-organic frameworks.

30. The device as recited in claim 27, wherein the sorption reservoir contains zeolites, activated charcoal, or metal-organic frameworks.

31. The device as recited in claim 24, further having a first connection via which it is possible to fill the sorption reservoir and a second connection via which it is possible to empty the sorption reservoir.

32. The device as recited in claim 25, further having a first connection via which it is possible to fill the sorption reservoir and a second connection via which it is possible to empty the sorption reservoir.

33. The device as recited in claim 30, further having a first connection via which it is possible to fill the sorption reservoir and a second connection via which it is possible to empty the sorption reservoir.
